(19) United States
(12) Patent Application Publication
(10) Pub. No.: US 2005/0273724 A1
(43) Pub. Date: Dec. 8, 2005

(54) Method and device for entering words in a user interface of an electronic device

(76) Inventors: Olaf Joeressen, Meerbusch (DE); Christian Scharff, Velbert (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/527,486

(22) PCT Filed: May 7, 2003
(86) PCT No.: PCT/IB03/01775

§ 371 Date: Mar. 11, 2005

(30) Foreign Application Priority Data
Oct. 3, 2002 (FI) 021759

(51) Int. Cl. G06F 3/00; G06F 17/30

(52) U.S. Cl. 715/773; 715/864; 707/3

(57) ABSTRACT

The present invention relates to character input methods for miniaturized electronic devices having a reduced user input interface, wherein the methods use the unequally distributed frequencies of words and numbers in a dictionary or a file to predict the most likely user input. The invention pertains to a method for entering a word into a user interface of an electronic device, wherein the characters of the word can be selected from a character set stored in the electronic device. The method comprises generating and displaying a character subset, the generating of a character subset for browsing of a character set which includes at least one character, wherein the character subset includes characters from among which, according to an inference logic, the next character for the word is most probably selected, and displaying the character subset on a display of the electronic device for browsing and selecting the next character.

The present invention relates to miniaturized electronic devices having a reduced user input interface. It also relates to character input methods that use the unequally distributed frequencies of words and numbers in a dictionary or a file to predict the most likely user input. More specifically, the invention is directly related to character prediction methods proposed for text input based on a rotator device such as Navi-Roller™ (Nokia).

Mobile phones today feature phone books and last dialed number lists to make the dialing of phone numbers faster and easier for users. Nevertheless many users enter some of their most frequently dialed numbers directly (like home number, office number, etc.) because they remember the number string. The invention relates to a method for entering text, words or strings of characters at a user interface of an electronic device, and to a text entry user interface for an electronic device.

Electronic devices, for instance subscriber terminals in a radio communication system, such as mobile telephones, are becoming smaller and smaller. At some point the keyboard of a device, for instance a 12-button character keyboard used in mobile telephones, will become useless since it becomes difficult and even impossible for a user to press buttons that are extremely small. It is thus the keyboard that becomes the limiting factor, which starts to restrict the design of mobile telephones. If the keyboard could be replaced by another input device, it would be possible to manufacture mobile telephones of a considerably smaller size, even of miniature sizes.

Various input devices can replace a character keyboard. The Nokia® 7110 mobile telephone, for example, employs a roller wherein the mobile telephone can be given different commands by rotating and pressing the roller.

A special problem associated with the use of an electronic device is the process of entering text. For instance, in ordinary mobile telephones employing a character keyboard, each button in the keyboard relates to several letters. A single button may, for instance, relate to the number 2 and the letters a, b and c. Pressing the button once produces the letter a, pressing the button twice within a short period of time produces the letter b, and pressing the button three times within a short period of time produces the letter c. Pressing the button four times in a fast succession produces the number 2. Pressing the button twice slightly more slowly produces two a's. As it is rather a slow process to use a keyboard in such a manner, various methods for entering text which employ a character keyboard have been developed. One example of such a method in which an object is to identify a word entered by a user is disclosed in U.S. Pat. No. 5,818,437 (Tegic Communications), which is incorporated herein by reference.

An object of the present invention is, however, to replace and/or supplement the character keyboard by another input device, which means that these prior art solutions cannot be used, at least not as such.

Such an input device is e.g. disclosed in U.S. Pat. No. 6,392,640 B1. The disclosed user interface and input method is based on a thumb-wheel input device and a two step character selection, to avoid 25 to 40 step dials to select a single character. The disclosed input method is based on a two step selection, wherein in a first step a subsection of an alphabet is selected e.g. A-D and in a next step the respective character is selected from this subsection, to reduce the number of necessary turning steps of the thumb-wheel.

Another proposed character prediction method for text input requires that every character is input correctly and unambiguously one after another. Therefore the dictionary is organized such that for any incomplete word the next N (e.g. N=5) most likely characters are given to the user for selection. This can be done statically if a fixed dictionary is used and a simple ordered list of preferred characters for each incomplete word can be stored (e.g. implicitly in a dictionary-tree).

Simple lists reflecting the probabilities of the next characters are very effective in terms of storage requirements and speed of execution. These lists however do not permit to take user behavior and new words into account properly because no information about the actual probability of the next characters (or words) is stored in the dictionary. It is not possible to insert new words properly even if their probability of occurrence is known since they cannot be compared to the probability of occurrence of existing words to guide the prediction process.

While other input methods (such as the T9 logic) make use of dictionary information they do not require probabilities since characters are not selected completely one after another. Once a complete word is typed ambiguities can be sorted out by presenting options to the user (in NOKIA phones by pressing the “*”-key). New words can simply be added to the list, which remains typically short even if the user has added many words to the dictionary.

In systems with no number keypads the user has to select each digit out of a list and confirm each selection which is usually quite slow and inconvenient.

It is desirable to have a faster and easier way for digit dialing and character input in systems where a full number keypad is not available and that is also applicable for rotator usage on other environments such as in a car environment, also selection of phone book entries by character entry shall be improved.

It is further desirable to have an input system that enables the manufacture of an ITU-T-(International Telecommunication Union—Telecommunications) keypad-less mobile telephone.

It is further desirable to have an ITU-T-Keypad-less mobile telephone that can intuitively be operated in a fast manner.

It would therefore be desirable to have a mobile phone supporting direct digit entry by prediction. This is even more desirable when no keypad is available to enter a word or a digit string. When using e.g. a rotator for digit entry each digit of a number must be selected out of a list (“+”, “0” . . . “9”) and the correct digit must be entered by pressing the OK or Enter button. It is desirable to speed up and improve a digit entry.

According to a first aspect of the present invention, there is provided a method for entering words into a user interface of an electronic device, wherein the characters of said words can be selected from a character set stored in said electronic device.

In the following and in the claims the term “word” is used for any kind of logically connected strings of characters such as words or telephone numbers. A word in the following text is not to be regarded as a sequence of letters that can be found in a dictionary, but refers to any kind of logically connected sequence of characters. So a word according to the use in the following specification and the claims text can be defined as a sequence of characters (including “space” or punctuation marks) such as words, expressions (that may include several words), numbers, telephone numbers, dialing code or the like. It may be noted that single words can be separated by spaces, but this is not necessary, as in the case of dialing code and telephone number.

The method according to one aspect of the invention comprises generating for browsing, a character subset of said character set which is made up of at least one character, wherein said character subset includes characters from among which, according to an inference logic, the next character for said word is most probably selected. Said method further comprises, displaying said character subset on a display of said electronic device, to enable a user to browse and select the next character from among said character subset. The method is characterized in that said inference logic is based on a database of words and at least one usage parameter related to each of said words. It may be noted that said at least one usage parameter for each of said words can be related to a single word or may also be related to “at least one word”. So a usage parameter can also describe a pair of words (e.g. their mutual succession) or a plurality of words. The usage parameter can also be related to a single sentence or a whole message, such as, e.g., a short message (SM) or any other text. For simplicity, the expression “usage parameter for each of said words” is used, as each word is related to at last one of said parameters, without the limitation that each parameter is related to only one word. This can also be derived from the preceding definition of a “word”, as a string of characters (including spaces, “wildcards”, numbers, punctuation marks and/or entities).

A subset of the most probable characters can be presented to the user to grant a fast access to the characters to be most probably selected. This is required to reduce the required number of steps a wheel input device has to be turned, so that a movement like repeatedly striking a flint of a nearly empty lighter can be prevented for selecting just a single character.

Naturally, the method can comprise the step of receiving input from a user for browsing the characters on said display, but this step is only optionally and is economized, if the user selects the most probable character proposed by the device. It is assumed the device proposes the most probable character in a way that it can be selected without browsing.

The expression “usage” and “usage parameter” is selected to describe different possible usage parameters.

The usage parameter may describe the individual number of occurrences of usage or frequency of usage of one of said possible words and the total number of used words.

The usage parameter can describe simply the number of occurrences of usage that is not related to the total number of used character strings.

In case of phone number entry the usage parameter can be related to phone numbers stored in the phonebook, i.e. phone numbers stored in the phonebook or in respective call lists are suggested preferably.

The usage parameters can be related to other personal content in the device (e.g. names related to stored image files).

The usage parameters may describe any other kind of knowledge, which is built up inside the terminal by the prior usage of the user of this terminal.

The usage parameter can additionally rely on externally supplied data i.e. language statistics and phonebook statistics.

In another example embodiment of the present invention, at least one of said usage parameters for a certain word is related to the individual number of occurrences of usage of said word.

In another example embodiment at least one of said usage parameters for a certain word is related to the individual number of occurrence of usages of said word and the total number of occurrences of words. So, the usage parameter can be embodied as a normalized frequency of usage of a certain word. So the usage parameter can represent the number of how often a word is used divided by the overall number of total words used. It should be clear that the distribution is the same if the parameters are not normalized, as both parameters differ only in a factor common to all parameters.

So, in contrast to the state of the art, the method according to the present invention relies primarily on the monitored user input to provide a user specific input prediction. Thereby, the user can use even low parameter input means for a fast input of words according to the above definition.

Yet another example embodiment of the method is characterized in that said least one usage parameter and said words are stored in a database comprising words and said at least one usage parameter e.g. of said electronic device. This example embodiment further comprises, adapting the contents of said database after at least one word has been selected or entered.

The expression of “at least one word” is used in this context to emphasize that the update of the database of words, the probabilities or usage parameters can be performed automatically after the input of a single word, a pair of words or a plurality of words. The expression of “at least one word” is used in this context to emphasize that the update of the database of words, the probabilities or usage parameters can be performed after the input of e.g. a single sentence or a whole message, such as e.g. a short message (SM). The expression of “at least one word” is used in the is context to emphasize that the update of the database of words or telephone numbers, the probabilities or usage parameters can be performed after the input of a part of a telephone number (e.g. a town dialing code or a country dialing code) or the number itself.

The adaptation of the contents of said database of words and said at least one usage parameter according to said selection can be performed by adapting at least one of said usage parameters (in dependence of the selected parameter), if the respective word is already in the system. The adaptation of the contents of said database of words and said at least one usage parameter according to said selection can be performed by adding a new word into the database and generating at least one new usage parameter, if the word is not in the system.

The adaptation of the database can be performed automatically after a complete word is entered. Another possibility is, that the database is updated after a user has entered a complete text (e.g. a SMS or a text). In the case of an SMS the database can be adapted (updated) after sending SMS. In case of writing a document (Text) the updating of said database can be performed after saving the document. By updating the database after the user confirmed his entries, it can be excluded that the database is also updated after the user made typing errors. Thereby it can be prevented that the system starts proposing typing errors, as an adaptive system starts “learning” even wrong words and grammar.

In contrast to standard character input methods using QWERTY-Keyboards or ITU-T Keyboards with or without T9 logics the present invention is based on a “select one of the displayed characters” principle. To speed up classical input configurations wherein it is required to browse from A to Z or from A to 0, the present invention uses a prediction logic to suggest a subset of most probable characters to be chosen.

Therefore, a character subset is generated that is made up of characters to be browsed, the character subset including characters from said character set from among which, according to an inference logic, the next character for said word is most probably selected. Therefor the number of steps to be performed with a thumb-wheel type input device could significantly be reduced.

At least the generated subset is displayed on the display for browsing the characters and for selecting the next character. Additionally, the user can browse the standard set of characters for a selection, if a desired character can not be found in the proposed subset. The standard set can comprise the subset or may be the standard set of characters without the characters of the proposed subset.

In a next step the displayed characters of the proposed subset and/or the standard set can be browsed on a display by receiving a user input via a user interface. It should be noted that in case that no characters may be proposed according to said determined inference logic, a standard set of the most frequent characters in a language could be presented. In case of English it would be the characters “ETIAO” having all in all a statistical probability of occurrence or frequency of 0.44.

The browsed character is then selected by received user input, and is added to a string of characters to form a word.

The method is further preferably characterized by adapting said determined inference logic according to said selection. That is, the present invention provides a self-learning user input prediction method. The system dynamically adapts itself to the way of self-expression of the respective user. The system dynamically adapts itself to the call behavior of the owner/user of an electronic device such as a mobile telephone.

In another example embodiment said determined inference logic is based on a database of words and usage parameters (or probabilities) related to said words and said adapting of said determined inference logic. This adaptation of the inference logic can be performed according to said user selection by adapting the content of said database of words and usage parameters. By using a database of words and usage parameters related to said words, the present invention can be applied to any kind of input structure words or inputs. In case of mobile telephones or thumb-wheel operated navigation systems or car setup menus, the present invention can be applied to any kind of input strings. For browsing e.g. the setup menu of a mobile telephone, the telephone proposes short cuts to user preferred branches of the user menu, by changing e.g. the succession of items in the menu bar. The present invention can be applied to any kind of language and is not limited to English. The present invention can also be applied to any kind of numeral input such as telephone numbers. The invention can be applied to simplify the input of telephone numbers and can be applied to name selection from phone book entries.

Yet another example embodiment of said method is characterized by generating a new word in said database of words to perform said adapting of said content. By generating new entries in said database the system can adapt itself to the user by widening the available data stock. The invention can start with a basic number of pre-stored words (user dictionaries) such as in the case of the T9 logic, and the invention can broaden this vocabulary according to (preferred) user inputs. So the prediction logic can be embodied as an automatically learning vocabulary database.

Another example embodiment is characterized in that said adapting of said content is performed by adapting at least one of said usage parameter or probabilities related to said words stored in said database of words. In particular the invention describes a method how new words can be added to the dictionary and how the usage parameters or probabilities of existing words in the dictionary can be altered to reflect the actual user preference and improve prediction performance.

According to the invention an indication (e.g. a usage parameter) reflecting the probability of occurrence of words (P_{O}(word)) in a text or in an input is added to each and all words in a dictionary. Secondly the number of words a user has input are counted as well as the number of occurrences for each word a user has input. It may be noted that the user most likely not types in the words, as the availability of a complete keyboard dispenses the need for any kind of input prediction. The present invention may be especially useful in case of languages with an alphabet that is based on syllables, like Japanese Hiragana and Katakana. The more single elements can be found in the alphabet of a language the more useful the present invention of prediction can be applied to simplify the input of a character. Especially in Japanese the number of turn of a thumb wheel should be reduced to enable a useful and applicable thumb-wheel input algorithm. The present invention can simplify the input of words and text. Based on the total number of words and the individual number of occurrences the probability of occurrence is estimated. This may involve additional heuristics rather than pure arithmetic in particular if the total number of words is still small to adapt quickly to user behavior although the statistical variance of the probability estimate is still very big.

The basic usage parameter or probability of occurrence of a word can be described as P_{O}(WORD)=(number of occurrences of WORD so far/total number of written words). This is best stored by counting both elements separately.

The same usage parameter or probability of occurrence of a telephone number or other strings of digits can be described as:
P_{O}(NUER)=(number of dials of NUMBER so far/total number of dials).

Other possible usage parameters or probabilities may be defied as:
P_{O}(NUMBER)={(number of dials of NUMBER so far/total number of dials)+(number of telephone connections to NUMBER so far/total number of telephone connections)}/2 This is best stored by counting both elements separately.

The method may be provided with an algorithm to optimize the selected probability to the behavior of the user.

To get best execution speed it is needed to build a decision tree for the prediction or some other database or structure, which provides the most probable characters quickly. This tree/database can be updated after a message is sent to avoid bad user interface response times. This is particularly true for the first few prediction steps that would otherwise involve processing the whole dictionary before suggesting the next character. After a number of characters a fully dynamic approach could be possible due to the limited number of words to be processed.

In addition to words also diphones (or syllables as in the Japanese language) can be used if no words are known that extend the characters typed so far. It is necessary to assign as well probabilities to those to avoid that they are completely removed if the user dictionary grows, although the probabilities of the involved words are very low.

The probability of occurrence for the initial dictionary can be done in any suitable format. They can be fixed or dynamic. However, if they are dynamic some kind of occurrence counter is needed in addition to the initial probability. Furthermore algorithms are needed to determine whether the pre-recorded probabilities or estimations should be used for.

With these estimations of the probability of occurrence the predictive text input methods can use words which were initially not in the dictionary in the same way as the words that were initially in the dictionary. This permits that the user experiences the prediction working betters the more he has been writing by learning the words and “style” of the user. The present invention may be set to prefer a user specific expression from the first input to a standard expression. The standard input together with a usage log file, rates a user input from the first input with a once selected value, above a standard expression with effectively no entry in the usage file. So the present invention provides on one hand a fast learning and fast adapting user specific dictionary.

Yet another example embodiment of the method further comprises storing said selections in a log file for determining new usage parameters. In this embodiment, said inference logic determines said subset of most probable characters by evaluating said log file. The log file can be embodied to comprise different log-statistics or log parameters such as last 5 or last ten used words which provides an actually preferred user behavior. The log file can comprise a statistical log to determine an absolute probability for each word that has been input since bringing the electronic device into service. The log file can be embodied as a composite log file comprising different kind of data stored to the use of single words. The log file can be provided with a kind of oblivion to ensure that rarely used user entries do not overcrowd the user dictionary. The oblivion can also be used as a kind of data or privacy protection of a user.

In another example embodiment, said method is characterized in that said words stored in said database of words are arranged in the form of a tree such that a root of the tree consists of a beginning of a word, the root being connected to nodes representing single characters on a next level such that on each level, potential characters are, in order of probability, connected to a node on a previous level whereby, as the process proceeds from the root of the tree through the nodes to a node on the last level, the characters in the nodes combine to form words in said database of words. By using such a data storage structure the amount of data to be stored can be reduced. The data structure is also very useful as the usage parameters or probabilities of single nodes can directly be derived from the usage parameters or probabilities of the words in the respective last levels of the tree. Each end of a twig of said tree can be provided with a counter to count how many times a single word has been entered, and to derive a probability for the first level nodes of the tree and for the other nodes. So in dependence of the used algorithm method can propose the 3 or 5 nodes with the highest probability (in the next level only or in all higher levels)

In yet another example embodiment said method is characterized in that in order to browse the characters on the display, the character subset is interlinked with the character set such that upon browsing past the character subset, the browsing of the character set begins.

By interlinking the character subset with the standard character set a user can browse to the standard character set in a fast manner. The interlinkage can be embodied to form a closed chain of the character subset, the character set and a set of numbers and punctuation marks. The interlinked character subset and character set can be displayed on the display in visually different manners, to provide a hint to the user that he is browsing different kind of character sets. This principle can be extended to displaying e.g. normal letters of the alphabet, numbers and/or punctuation marks in different fonts/colors. To reduce the set of characters, all the characters the subset removed from said set of characters

The browsing can be embodied as a chain or column of characters scrolling over a display displaying only a small section of said scroll or column in a rosary style. Alternatively, the sets of characters may be fully displayed on the display and a cursor can be moved by an input device. For the use in darkness or by visually handicapped people the electronic device may also output the selectable and selected characters or words by speech synthesis.

In an other example embodiment, said input prediction with said determined inference logic comprises identifying a start of an entry of a new word, inserting, into the character subset, the most probable letters stored in the database of words for starting a word. This can be embodied by selecting the nodes with the highest probability in the first level.

The present invention can be extended by suppressing single words in the database for the second or a few following entries, as it can be expected that a user is not going to use the same word for several times in direct succession. In case the device provides enough storage and processing power the present invention can also be extended with probabilities for the successions of different words. So it can easily be prevented that same or like words follow each other, and additionally frequently used idiomatic expressions or phrase can be recognized with an increased probability. An easy way to provide probabilities for successive words is to provide a probability tree with a two-word depth. That is, two successive words are regarded as a single word and the probability for the succession of the two words is coded in the nodes of a successive tree. As stated above, the definition of a word as a string of characters also comprises the definition of two successive strings of characters and (e.g. a “space”) in between as a word. So in the case that a second word in a sequence is usually comprised of a specific subset of word as e.g. in starting a message “Hi, Suzie . . . ”, that is two starting words can be regarded as a single sequence of characters (i.e. a word). So the Device is able to predict the next input by proposing one of “Hi, Bernd . . . ”, “Hi, Jack . . . ” and the like. Depending on the number of usage parameters, and the processing power provided in the device, the device may also be able to predict that a word following an expression such as “Hi, . . . ”, “Hello, . . . ”, “AVE . . . ”, “Salu . . . ” or the like is most probably to be followed by a name. It is clear that such a sophisticated provision of requires many of statistic information about a language. Incas of a telephone, this would only require a small short cut to the telephone register, although this may lead to message heading s such as “My sweet, Jody mobile . . . ”.

Another example embodiment said method is characterized in that said determined inference logic comprises identifying a text to be entered, identifying words being stored in said database of words that are appropriate for the word or text being entered and selecting, for the character subset, a character from each appropriate probable entry to be possibly entered next. That is the search for the most probable character(s) continues to the next level of nodes in the probability tree.

Thereby, the present invention can distinguish between “word” and “text” (wherein words are parts of a text). Wherein a “word” is defined as a string of digits or letters, and a “text” is defined as a string of letters, digits and characters, comprising words as sub-elements or sub-entities. The analogy is clear in case of plain text in case of the telephone number example a word can be a dialing code, a firm telephone number or direct dialing code (in a PBX), wherein the text is represented by the number composed of these elements (so the words and the text form plain strings of digits).

According to yet another aspect of the invention, a software tool is provided comprising program code means for carrying out the method of the preceding description when said program product is run on a computer or a network device.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to another aspect of the present invention a computer data signal is provided. The computer data signal is embodied in a carrier wave and represents a program that makes the computer perform the steps of the method contained in the preceding description, when said computer program is run on a computer, or a network device.

The software prediction module can be implemented to run on a controller and to use a non volatile memory to store the frequency of number dialing and a list of all dialed numbers.

The list of all dialed numbers could be shared with the last dialed number list to reduce memory usage. Also memory sharing with the phone book could reduce memory requirements.

The implementation can be done in software by implementing the above-described methods.

According to another aspect of the present invention an electronic device is provided that comprises at least a display, an input device, and a processing unit. Said display is for displaying characters, entered characters and character strings, and character sub-strings. Said input device is for issuing commands to browse and select characters. Said processing unit is for controlling the operation of the user interface. Said processing unit is connected to the display and configured to display characters on the display. Said processing unit is further connected to the input device. Said processing unit is configured to receive, from the input device, commands to browse and select characters. Said processing unit is further configured to generate for browsing, a character subset made up of characters to be browsed, wherein said character subset includes the characters of a character set from among which, according to an inference logic configured into the processing unit, the next character for the word is most probably selected by a user. Said processing unit is further configured to display the character subset on the display for browsing the characters and for enabling a user to select the next character by using the input device.

Said electronic device is characterized by further comprising a database of words and at least one usage parameter related to each of said words. Said database is connected to said processing unit, and said processing unit is configured to select said character subset according to said inference logic on the basis of said words and said related at least one parameter.

Basically the device according to the invention is configured to select the subset on basis of usage parameters or usage statistics stored in a database in said electronic device. A device according to the present invention can be embodied with a separate word-usage statistics database.

In another example embodiment said processing unit is further configured to adapt the content of said database of words and usage parameters according to selections of a user received from said input device. Thereby the device according to the present invention can be configured to adapt the usage parameters automatically according to the preferences of the user. As the inference logic is based on the parameters, the proposed character subsets are automatically adapted to the preferences of a user.

In another example embodiment of the present invention said input device for issuing commands to browse and select characters comprises at least one of the following input devices:

A roller wherein browse commands are issued by rotating the roller around its axis, and/or wherein select commands are issued by pressing the roller. The operability of such rollers can be enhanced by adding a switch that can be operated by moving the roller in an axial direction. If the roller is mounted with the axis at an edge of a device, the roller may trigger a switch by a shifting movement parallel to one of the surfaces forming said edge.

A disc wherein browse commands which are issued by rotating the disc coplanarly clockwise and anti-clockwise, and/or wherein select commands are issued by pressing the disc,
Arrow buttons can be used to enter browse commands, which are issued by pressing the arrow buttons, a selection button can enter select commands by being pressed.

A joystick can be used to enter browse and/or select commands are issued by moving the joystick.

A trackball provides browsing and/or select commands by rotating the trackball, and/or wherein select commands may be issued by pressing the trackball.

A touch pad can be used to enter browse and/or select commands by touching the touch pad.

A dial slide. A dial slider or dial slide is a small spring-loaded slider with basically the same functional principle as the conventional dial disc. The dial slide can be embodied as a small indented bar with different number on said recesses. A telephone dial slider can comprise at least ten dents numbered from 1 to 0, and may be additional two dents to code # and *. The dial slide is a linear version of a conventional dial which may be nearly arbitrarily be miniaturized as the 10, 12 ore more dents can be operated if the single recesses can be engaged by a fingernail to slide the slider until the fingernail abuts to a stop, limiting the movement of the slider. The single numbers can be coded by the linear position at which the movement of the slider is stopped. The slider can quickly return to the initial position, as in contrast to the conventional dialing disc the single number is not coded in the time required to resume the original position of the dial.

In the following, the invention will be described in detail by referring to the enclosed drawings in which:

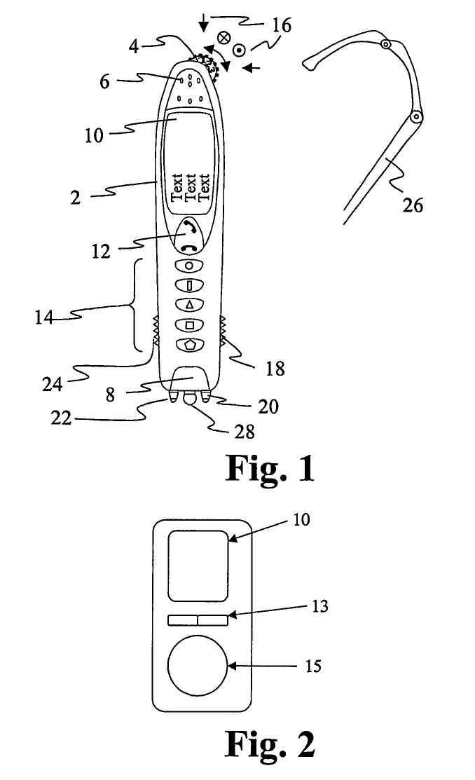

FIG. 1 is a diagram illustrating an electronic device according to one embodiment of the present invention,

FIG. 2 is an example of a mobile telephone according to the invention with a rotator input device

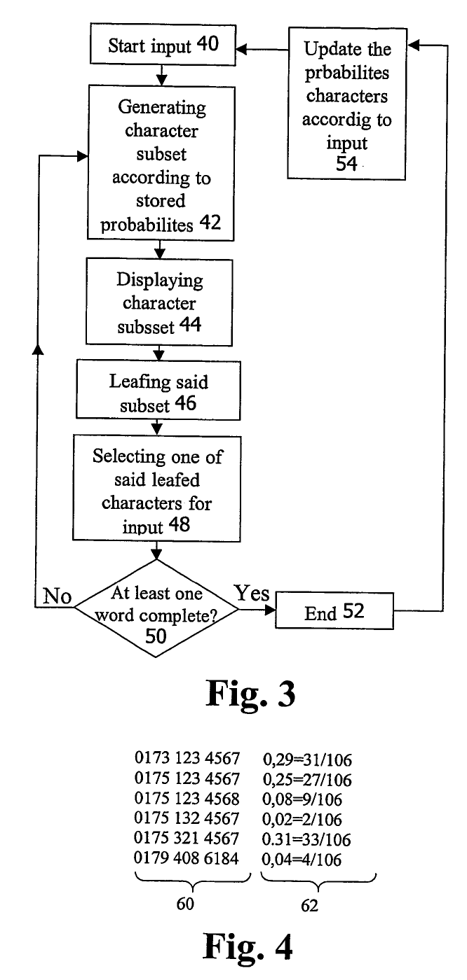

FIG. 3 is a flow diagram illustrating a method for entering a word at a user interface for an electronic device,

FIG. 4 is an example of a possible word database comprising 6 different telephone numbers and their respective probability values (a usage parameter),

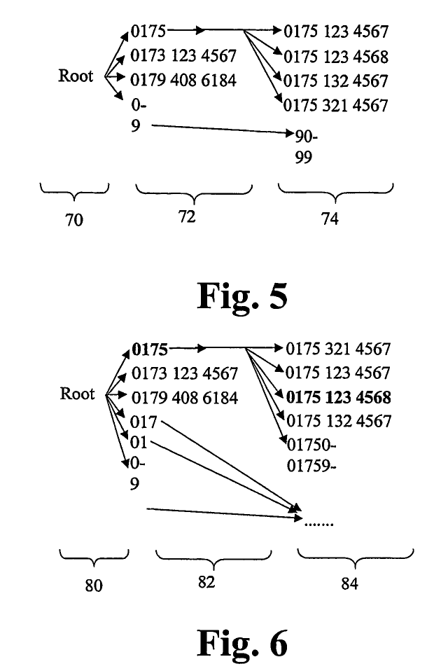

FIG. 5 is an example of a fist probability tree according to one embodiment of the present invention,

FIG. 6 is an example of a second probability tree according to another embodiment of the present invention,

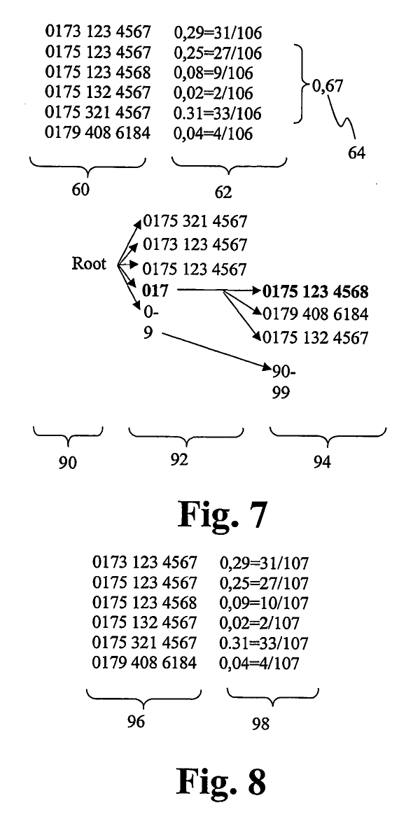

FIG. 7 is an example of a second probability tree according to another embodiment of the present invention,

FIG. 8 is an example of a new set of usage parameter values according to an aspect of the present invention,

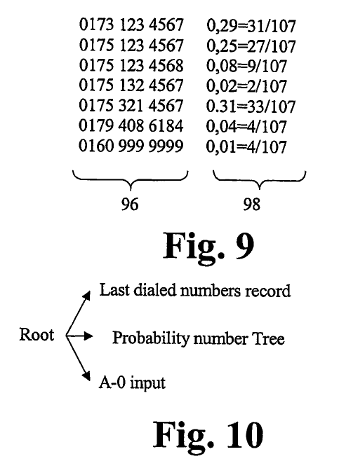

FIG. 9 is an example of a new set of usage parameter values according to an other aspect of the present invention, and

FIG. 10 is an example of a super root-menu structure.

Referring to FIG. 1, an example of an electronic device 2 is described. The device may be e.g. a portable device relating to Ubiquitous Computing, e.g. a subscriber terminal in a radio system, such as a mobile telephone system, a PDA (Personal Digital Assistant) device or another electronic device equipped with a text entry user interface 4. In our example of FIG. 1, the device is a subscriber terminal in a telephone system. The example used being a subscriber terminal, the device comprises an antenna and a radio transceiver (both not depicted). The radio transceiver is e.g. a prior art transceiver for a mobile station, operating e.g. in a GSM (Global System for Mobile Communications) system, GPRS (General Packet Radio Service) system or in a UMTS (Universal Mobile Telecommunications System).

A rechargeable battery (not shown) usually serves as the power source for a subscriber terminal. The device further comprises a processing unit (not shown) to control and monitor the operation of the device and different parts thereof. The processing unit further includes application software of the device, e.g. for radio signal processing, information processing and for controlling the operation of a user interface. The device thus comprises a memory in connection with the processing unit for storing information. The memory can be implemented by known methods for implementing a non-volatile memory, e.g. as memory circuits and possibly as a small hard disk. Today, a processing unit is usually implemented as a processor including its software, but different hardware configurations are also possible, e.g. a circuit built using separate logic components or one or more ASIC's (Application-Specific Integrated Circuit). If necessary, more than one processor may also be provided. A hybrid of these different implementation methods is also feasible. While selecting the mode of implementation, a person skilled in the art takes into account the requirements set for the size and power consumption of the device, the necessary processing capacity, manufacturing costs as well as manufacturing volumes.

The configuration of the processing unit constitutes structural entities that can be implemented using a programming language, e.g. C programming language, C++ programming language, a machine language, or as software modules, also known as routines, encoded by an assembler or e.g. the platform independent java language. Compiled routines constitute software to be stored as a runable version in a memory provided in connection with the processor and to be run by the processor. Instead of compiled programming languages, interpretable programming languages may also naturally be used, provided that their use fulfils the required processing rate and capacity. When the processing unit is implemented as ASIC, the routines are ASIC blocks.

The subscriber terminal further includes (connected to the processing unit) components for implementing the user interface: a microphone 8 and a loudspeaker 6 for processing voice, a display 10 for displaying information and input devices 4, 12 and 14 for controlling the device, for entering information and for issuing commands to process information.

The text entry user interface of the device is thus made up of the display 10 to display the characters and the entered text, the input device 4 to issue commands to browse and select the characters, and the processing unit to control the operation of the user interface. The input device 4 for issuing commands to browse and select the characters is embodied as a thumb-wheel type input device. The thumb-wheel type input device 4 can be pushed in different directions 16, for a first input directly from the right side e.g. for a direct input or a selection, directly from above e.g. for a deletion of the last or the selected character. The thumb-wheel type input device 4 can be pushed in different directions, for a first input vertically into the drawing plane or vertically out of the drawing plane to change the position of a cursor in the already entered part of the word or string of characters. The thumb-wheel can also be turned to browse the subset and the set of characters depicted on the display 10.

Typical examples of other pointing devices include:
arrow buttons 14 wherein browse commands are issued by pressing the arrow buttons,
a selection button wherein select commands are issued by pressing the selection button,
a joystick wherein browse and/or select commands are issued by moving the joystick,
a trackball wherein browse commands and/or select commands are issued by rotating the trackball, and/or wherein select commands are issued by pressing the trackball,
a touch pad wherein browse commands and/or select commands are issued by touching the touch pad,
a single button that can be operated by keeping the button pressed until the desired character appears under a cursor which is then being selected upon the release of the button. Two times shortly pressed provide a deletion of the last entered character, and a short press followed by a long one leads to scrolling in the other direction.
a thumb-wheel type input device may also be operated with an integral function operation wherein the angular position is actually related to the actual scan/browse speed.

Due to the miniaturization of the depicted mobile phone 2, a number of different features can be implemented in the phone with nearly no extra effort. The miniature phone 2 can be provided with a retractable refill for a ballpoint pen 20, to provide a simple writing option. A bolt 18 may operate the refill 20. Similarly a (retractable) digital pen 22 can be provided to be able to generate hand written text or e.g. SMS telefax in the mobile device 2. The digital pen functionality may also be retractable and be securable by a bolt 24. Due to the small size of the phone, the phone may be provided with a pullout antenna 28 on the bottom of the device. The pull out antenna 28 may be provided with a microphone or with a respective tube to conduct spoken voice to an internal microphone.

The miniature phone can also be provided with a retractable and/or foldable earpiece 26 to provide a hands-free operability by hooking the whole telephone on an ear as in the case of conventional hook-on headsets. So, the whole phone may be regarded as its own headset.

FIG. 2 is an example of a mobile telephone according to the invention with a rotator-input device. The functionality of the present invention can also be implemented in a much simpler device comprising just a display 10, menu keys 13 and a plate-shaped or circular rotary switch or turntable 15. The turntable 15 can be placed where a normal mobile phone has its ITU-T keypad. The bigger the turntable, is the more different characters can be selected with a single turn of the turntable, decreasing the number of input movements required for an input. The turntable can comprise a recess for a fingertip to provide a one-finger operability of the turntable. The basic functionality of the phone is the same as described in the method claims and the specification. A large central user input turntable provides a superior two-hand operability. The rotary switch or turntable 15 can also be embodied as a dial known from old-fashioned dial phones. Such a phone can be embodied with a generally circular shape with the size of conventional dial, a display (and menu keys) in a fixed hub of the dial and a spring force loaded dial, to provide said old fashioned dialing experience.

Next, referring to the flow diagram of FIG. 3, a method for entering a word or a text at a user interface for an electronic device will be described. The process starts at 40. Next, in 42, a character subset of the characters to be browsed is generated for browsing, the character subset including the characters of the character set from among which, according to a predetermined inference logic, the next character for the text is most probably selected. The character subset generated is displayed in accordance with 44 on the display for browsing the characters and for selecting the next character. In an embodiment, the character subset is displayed as a character string, the character subset including three to six characters, or five characters.

The process of entering characters is continued at 46, wherein characters are browsed or leafed on the display and, furthermore, to 48, wherein one of the browsed characters is selected or entered for the word/text.

In 50, it is tested whether or not to stop the process of entering characters of at least one word. This can be embodied by the identification that a singe word, sentence or text has ended, e.g. by the recognition of the input of a space (for a word), a punctuation mark (for a sentence) or the like.

If the at least one word is not complete, the process returns from 48 to 42.

If the process of entering at least one word is completed, the process moves from 48 to 52, wherein the execution of the input of at least one single word ends. In the next step 54 the stored probabilities are adapted to the last input of at least one word, and the process returns to the start 40, waiting for a new character input to generate a new subset according to the actualized probabilities. The update can simply comprise a new set of probabilities, if the last word is already present in the user dictionary or the storing of a new word (e.g. with the probability of one divided by the total number of entered words). The expression of “at least one word” is used in the is context to emphasize that the update of the database of words, the probabilities or usage parameters can be performed automatically after the input of a single word, a pair of words or a plurality of words. The expression of “at least one word” is used in the is context to emphasize that the update of the database of words, the probabilities or usage parameters can be performed after the input of e.g. a single sentence or a whole message, such as e.g. a short message (SM). The expression of “at least one word” is used in the is context to emphasize that the update of the database of words or telephone numbers, wherein the adaptation of probabilities or usage parameters can be performed after the input of a part of a telephone number (e.g. a town dialing code or a country dialing code) or the number itself.

The method can be expanded by a confirmation step (not shown) inserted between the end 52 and the update of the probabilities 54. By using a confirmation step the system becomes robust in regard of input errors, as the user can correct the at least one word or text before the updating of the usage parameters.

Another usage parameter that can be employed may e.g. describe the position of a word in a sentence. So the word “Hello” is supposed to be usually found in the beginning of a sentence or a text, while the words “so long” are usually found at the end of a text. This information can also be considered in the generation of the next character subset.

In an embodiment, the predetermined inference logic comprises: identifying a start of an entry of a new word, and inserting, into the character subset, the most frequent word starting characters of the character set used.

In an embodiment, the predetermined inference logic comprises: identifying, in the text being entered, letters relating to the word being entered, identifying candidate words appropriate for the word being entered by using a stored main vocabulary of the language used, and selecting, for the character subset, a character from each candidate word to be possibly entered next.

In an embodiment, the words in the main vocabulary are arranged in the form of a tree such that a root of the tree consists of a beginning of a word. The root is connected to nodes representing single characters on a next level such that on each level, potential letters are, in order of frequency, connected to a node on a previous level. Then, as the process proceeds from the root of the tree through the nodes to a node on the last level, the characters in the nodes combine to form a word in the main vocabulary. In an embodiment, the predetermined inference logic comprises: generating a character combination by using at least one character already used and a character to be possibly entered next, checking the probabilities of different character combinations from a databank containing the probabilities (i.e. usage parameters) of the different character combinations for the language used, and selecting, for the character subset, a character from each most probable character combination to be possibly entered next.

In an embodiment, in order to browse the characters on the display, the character subset is interlinked with the character set such that upon browsing past the character subset, the browsing of the character set begins. The interlinked character subset and character set may be displayed on the display in visually different manners. The method can also be applied for entering text in an application wherein the entered text generates an entry by which the desired information is found in a stored database. In an embodiment, the predetermined inference logic then comprises: identifying a start of an entry of a new word, and inserting, into the character subset, the most frequent letters in the stored database starting an entry. In an embodiment, the predetermined inference logic comprises: identifying, in the text being entered, letters relating to the word being entered, identifying entries in the database that are appropriate for the word being entered, and selecting, for the character subset, a character from each entry to be possibly entered next. The display may also display the entries that most closely correspond with the word being entered. Suitable devices for executing the method include an electronic device of the type described above, however, other kind of devices which include a display and an input device as a user interface and which benefit from entering text in the above-described manner may also be suitable for executing the method. Although the invention has been described above with reference to the examples according to the accompanying drawings, it is obvious that the invention is not restricted thereto but can be varied in many ways within the scope of the attached claims. In the examples, the use of the invention has been described using the Roman alphabet but the basic ideas can also be applied to other character sets as well, e.g. to Cyrillic characters, Greek characters, Hebrew characters or the like. The inference logic described in the examples operates on a word level but it can also be applied to a grammatical level.

FIG. 4 is an example of a probable word database comprising 6 different telephone numbers and their respective usage parameters (probability values). In FIG. 4 there is depicted a number of 6 arbitrary telephone numbers 60, i.e. 01731234567 to 01794086184. These telephone numbers are stored e.g. in a “last dialed record” in a mobile telephone, as it is known in the state of the art. The database of the phone is further provided with usage parameter or a statistic storage storing the individual use of each number in relation to the total number of set up connections.

The probability values may be also provided for the last e.g. 5, 10 or 100 connections, the last e.g. 5, 10 or 100 attempts and the like. In case that different statistics or usage parameters are used, the inference logic can be tailor made to the call or word input behavior of a single user.

To each of telephone numbers 60 a probability or a usage parameter value is assigned. In the present example the rounded probability is calculated by dividing the usage set up connections to a single telephone number (31, 27, 9, 2, 33, 4) by the total number of set up connections (106). The following figures are based on this starting point.

FIG. 5 is an example of a fist probability tree according to one embodiment of the present invention. In FIG. 5 the input of the telephone numbers starts with a root menu 70. In the first step the inference logic supposes the first three most probable input parameters sorted according to their probabilities. In this first step the system proposes the word (here a telephone number) starting elements 0175, 0173, 0179, and in case of no such input a standard character set 0-9. So FIG. 5 is based on a level specific of word length bases subset selecting principle. In contrast to the standard selection of input characters the present root selects the nodes of a higher level, if the next node comprises no branching. That is the system or the logic proposes the highest possible unambiguously reachable node that can be proposed. So in the case that a root related to a word comprises no additional branching (i.e. lead only to a single word), the whole word can be proposed, once this word is the only choice that can be proposed. The same principle can also be applied to the character or variable scale wherein the next group of characters up to the next branching node is proposed. Therefore, the system leaps to a 4 character starting sequence of 0175 and the other two complete telephone numbers 01731234567 and 01794086184. In case the user wants to select one of the complete numbers, the selection can be completed with the next input. In case one of the numbers starts with 0175 . . . the user simply needs to select these four numbers in successive steps, to set up the connection.

FIG. 6 is an example of a second probability tree according to another embodiment of the present invention. In contrast to the example of FIG. 5 the user can select any shorter fraction of the most probable number as s start for an input of a telephone number in the steps 80, 82 or 84 of the present method. Thereby the input of a new telephone number word is significantly simplified.

FIG. 7 is an example of another probability tree according to another embodiment of the present invention. In this embodiment the entries with the highest probability are presented. In the present case these are the telephone numbers with the probabilities of 31, 29, and 25 percent. So by proposing these tree numbers in the first step, the desired number can be selected in a single step with a probability of about 75 percent. The remaining 25 percent can be selected by a two-step input.

FIG. 8 is an example of a new set of usage parameter values according to an aspect of the present invention. The depicted set of new usage parameter values is generated if a user has selected one of the telephone numbers present in the telephone database. It can be seen that the probability of the selected number 01751234568 has risen from 0.08 to 0.09.

FIG. 9 is an example of a new set of usage parameter values according to an aspect of the present invention. The depicted set of new usage parameter values is generated if a user has entered a new telephone number that has not been present in the telephone database. It can be seen that the probability of the newly entered number 016099999999 has been generated with 0.01 which is approximately 1/107. Wherein 107 is the new total number of dialed telephone numbers or set up telephone connections.

FIG. 10 is an example of a super root menu structure. In such a structure a user my select which kind of approach to enter or select a telephone number may be chosen. In a first case by browsing the “last dialed number” record, in the second case by using a probability number tree as proposed by the present invention, or by an alphanumerical input.

It should be clear that the method is described in an exemplary fashion by using telephone numbers can readily be applied to any kind of words or character strings, independently of the kind of characters or the language used.

The strength of the system of the present invention resides in a fast access to a relatively low number of database entries with a one-finger operable interface device on a small mobile electronic device. Although the present invention is directed to miniature devices it can also be applied to any kind of roll and click input devices, under the condition that the input of a user is related to a low number of input variables.

A digit entry prediction system that uses the internal logic and order of the (telephone) numbers and the number of dialing said telephone numbers to predict the next digit the user wants to enter. If, for example the most frequent dialed phone number is +491716975573 and the user starts to dial this number by entering the “+” sign, then the next suggested number by the prediction system is the digit “4”. The user can accept this digit by pressing OK or Enter. After this the next suggested digit is “9” and so on. In this case there is no need for the user any more to scroll through the complete list of digits (“+”, “0” . . . “9”) to select and enter the next digit.

The inherent behavior of such a system is that the accuracy of the prediction increases the more digits of a number are entered. The number the user wants to dial can be predicted by the system very accurate the more digits are known to the prediction module. The system uses a tree like structure to find the next probable digit out of the list of known numbers and probability of dialing.
Number with the highest probability: +492349843632
Number with second highest probability +492349844500

The user wants to dial +492349844500 in the following example:

| | User |
|---|---|
| System | User enters + |
| System suggests 4 | OK |
| System suggests 9 | OK |
| System suggests 2 | OK |
| System suggests 3 | OK |
| System suggests 4 | OK |
| System suggests 9 | OK |
| System suggests 8 | OK |
| System suggests 4 | OK |
| System suggests 3 | Correct to 4 |
| System suggests 5 | OK |
| System suggests 0 | OK |
| System suggests 0 | OK and dial |

In the next step the system adapts the probabilities of said telephone numbers to the received input.

| | |
|---|---|
| In another example embodiment, | |
| System starts by suggesting +49234984 | OK |
| System suggests 3 | Corrects to 4 |
| System suggests 500 | OK and dial |

In the next step the system adapts the probabilities of said telephone numbers to the received input.

In the second example the system starts by suggesting the most probable sub-string to follow.

This reduces the number of necessary inputs from 12 to 3, significantly speeding up the input of a (pre-stored) telephone number.

It is also possible that the system only suggest only the most probable next character of digit as the most probable next user input. That is the expression “browsing” in the claims describes the selection or non-selection of a single proposed character. This can be very useful if the user is not used to use the proposed selection, offering an easy way out to standard character selection. Although this may provide only a single option, as single proposes character is sufficient for the present invention. The advantage of the present invention resides in a faster input of digits in the case the prediction comes up with the right digits, and there is no disadvantage if the prediction suggests a wrong digit, expect of the fact that a user has to scroll away from said suggested subset.

Other advantages reside in that
the dictionary is learning enabled (or at least made very effective) together with the predictive input,
the user experience is improved,
the effectiveness of predictive input is increased
the methods that try to implement a similar user experience without involving probabilities will have to be based on heuristics that will most likely lead to strange side effects (since the system cannot really know, how often a user will use a certain word without counting) such as proposing rare words all the time and not recognizing/proposing frequent words.
that all new words can be added automatically to the user dictionary since words that occur only once in a lifetime will not spoil the prediction engine due to their low probability.
the method is based on probabilities and a user dictionary of limited size that is easier to maintain since rare words are known and can be removed. However, new words need to remain for some time to permit that the probability can build up before the word is removed due to its low probability.

In contrast to the small disadvantage of a slightly increased SW complexity, the present invention provides a great progress in user friendliness and operability.

Analogue to the well known T9 logic in the technical area of generating text input in a mobile electronic device too small to hold a whole Qwerty-Keyboard, the present invention provides a possibility for a fast input of a text of words with a user input interface with even less possible input parameters.

The invention may also be combined with the known T9 logic. The device may present in a first stage one of the 10 keys as known form a ITU-T keyboard and in a second stage generating all the words on a scroll bar for selection, and using the present invention to speed up the adaptation of the T9 vocabulary to the preferences of the user. The input can use a T9-logic in the first steps and utilize the invention as soon as the number of probable words has been restricted to a manageable number of words.

The invention becomes visible to any user since different words will be proposed by the prediction SW after some period of learning.

It should be clear that the system could arbitrarily change the proposed subset from letters to numbers or punctuation marks. So if the system detects a keyword such as the abbreviation “St” for Street the system can automatically propose the input of a dot, followed by a space and a respective proposal of digits.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. A method for entering a word into a user interface of an electronic device, wherein the characters of said word can be selected from a character set stored in said electronic device, comprising:
generating, for browsing, a character subset of said character set, said character subset including characters from among which, according to an inference logic, the next character for said word is most probably selected,
displaying said character subset on a display of said electronic device, for browsing and selecting the next character by the user,
characterized in that said inference logic is based on a database of words and at least one usage parameter related to each of said words, and
wherein said user interface is a roller, and wherein browse commands are issued by rotating the roller around its axis, and wherein select commands are issued by pressing the roller.

2. The method according to claim 1, wherein said at least one usage parameter for a certain word is related to the individual number of occurrences of usage of said word.

3. The method according to claim 2, wherein said at least one usage parameter for a certain word is related to the individual number of occurrence of usages of said word and the total number of occurrences of words.

4. The method according to claim 1, wherein said at least one usage parameter and said words are stored in a database comprising words and said at least one usage parameter, characterized in that said method further comprises:
adapting the contents of said database after at last one word has been selected.

5. The method according to claim 4, characterized in that said adapting of said database is performed by adding a new word to said database.

6. The method according to claim 1, further comprising storing said selections in a log file for determining new usage parameters, and wherein said inference logic determines said subset of most probable characters by evaluating said log file.

7. The method according to claim 1, characterized in that words stored in said database of words are arranged in the form of a tree such that a root of the tree consists of a beginning of a word, the root being connected to nodes representing single characters on a next level such that on each level, potential characters are, in order of probability, connected to a node on a previous level whereby, as the process proceeds from the root of the tree through the nodes to a node on the last level, the characters in the nodes combine to form a word in said database of words.

8. The method according to claim 1, characterized in that, the character subset is interlinked with the character set, in order to browse the characters on the display, such that upon browsing past the character subset, the browsing of the character set begins.

9. The method according to claim 1, characterized in that said input prediction with said inference logic comprises:
identifying a start of an entry of a new word,
inserting, into the character subset, the most probable letters stored in the database of words for starting a word.

10. The method according to claim 1, characterized in that said inference logic is operated by the steps comprising:
identifying a text being entered, wherein the characters of said text relating to a word are entered,
identifying words being stored in said database of words that are appropriate for the word being entered, and
selecting, for the character subset, a character from each appropriate probable entry to be the possibly entered next.

11. A software tool comprising program code means stored on a computer readable medium for carrying out the method of claim 1 when said software tool is run on a computer or network device.

12. A computer program product comprising program code means stored on a computer readable medium for carrying out the method of claim 1 when said program product is run on a computer or network device.

13. A computer program product comprising program code, downloadable from a server for carrying out the method of claim 1 when said program product is run on a computer or network device.

14. A computer data signal embodied in a carrier wave and representing a program that instructs a computer to perform the steps of the method of claim 1.

15. An electronic device, comprising a user interface for entering words comprising:
a display (10) for displaying characters and entered characters and character strings,
an input device (4) for issuing commands to browse and select characters, and
a processing unit for controlling the operation of the user interface, the processing unit being connected to the display and configured to display characters on the display, the processing unit being further connected to the input device and configured to receive, from the input device, commands to browse and select characters, wherein said processing unit is further configured to generate for browsing, a character subset made up of characters to be browsed, the character subset including the characters of a character set from among which, according to an inference logic configured into the processing unit, the next character for the word is most probably selected, and display the character subset on the display for browsing the characters and for selecting the next character by using the input device (4),
characterized by a database of words and at least one usage parameter related to each of said words, wherein said database is connected to said processing unit, and wherein said processing unit is further configured to select said character subset according to said inference logic on the basis of said words and said related at least one usage parameter,
wherein said input device (4) is a roller, wherein browse commands are adapted to be issued by rotating the roller around its axis, and wherein select commands are adapted to be issued by pressing the roller.

16. The electronic device according to claim 15, wherein said processing unit is further configured to adapt the content of said database of words and said at least one parameter according to selections of a user received from said input device.
